(19) United States
(12) Patent Application Publication
(10) Pub. No.: US 2023/0073834 A1
(43) Pub. Date: Mar. 9, 2023

(54) SUBNORMOTHERMIC MACHINE PERFUSION OF ORGANS WITH CARBON MONOXIDE AND OXYGEN

(71) Applicant: Patrick LUKE, London (CA)

(72) Inventor: Patrick LUKE, London (CA)

(21) Appl. No.: 17/894,686

(22) Filed: Aug. 24, 2022

Related U.S. Application Data
(60) Provisional application No. 63/237,119, filed on Aug. 25, 2021.

(51) Int. Cl. A01N 1/02

(52) U.S. Cl. CPC A01N 1/0247; A01N 1/0284

(57) ABSTRACT

A gas exchanger for a perfusion circuit for circulating organ preservation solution to and from a harvested donor organ, the gas exchanger comprising: (i) an inlet for receiving oxygen and CO from an oxygen reservoir and a carbon monoxide (CO) reservoir, (ii) an inlet for receiving the organ preservation solution from the perfusion circuit, (iii) an outlet gas out to environment, and (iv) an outlet for delivering the organ preservation solution treated with oxygen and CO (treated preservation solution) to the perfusion circuit. Also, a system comprising the gas exchanger and the perfusion circuit for circulating the organ preservation solution to and from the harvested donor organ and a method to preserve a donor organ comprising perfusing the donor organ with a mixture of carbon monoxide and oxygen at room temperature.

### CROSS REFERENCE TO RELATED APPLICATIONS

This application claims the benefit under 35 U.S.C. 119(e) of U.S. Provisional Ser. No. 63/237,119 filed Aug. 25, 2021, the contents of which are hereby incorporated by reference into the present disclosure.

### FIELD OF TECHNOLOGY

The present disclosure relates to machine perfusion of organs with carbon monoxide and oxygen and subnormothermic methods to preserve a donor organ comprising perfusing the donor organ with a mixture of carbon monoxide and oxygen at room temperature.

### BACKGROUND INFORMATION

With patients dying on the transplant waiting list, there is a great need for good quality donor organs. Commonly, organs are discarded because of donor disease, injury sustained during the death, inadequate procurement and storage process using contemporary techniques. We require a better way to protect organs and prevent further damage in order to utilize a greater number of organs and optimize them to increase patient survival.

### SUMMARY OF DISCLOSURE

In one embodiment, the present disclosure provides a gas exchanger (5) for a perfusion circuit for circulating organ preservation solution to and from a harvested donor organ, the gas exchanger comprising: (i) an inlet (51) for receiving oxygen and CO from an oxygen reservoir (10a) and a carbon monoxide (CO) reservoir (10b), (ii) an inlet (52) for receiving the organ preservation solution from the perfusion circuit, (iii) an outlet gas (9) out to environment, and (iv) an outlet (53) for delivering the organ preservation solution treated with oxygen and CO (treated preservation solution) to the perfusion circuit.

In one embodiment of the gas exchanger of the present disclosure, the gas exchanger further comprises the oxygen reservoir (10a) and the carbon monoxide (CO) reservoir (10b) connected to the inlet (51) for receiving oxygen and CO.

In another embodiment of the gas exchanger of the present disclosure, the harvested donor organ is one of heart, kidney, liver, lung, pancreas, intestine, thymus or uterus.

In another embodiment of the gas exchanger of the present disclosure, the harvested donor organ is a harvested donor kidney, and the organ preservation solution is a kidney preservation solution, and wherein perfusion circuit comprises: (a) a kidney cassette (7a) configured for storing the harvested donor kidney during a preservation period and for storing the kidney preservation solution, (b) a kidney preservation solution reservoir (7b) configured for storing the kidney preservation solution, (c) a pump (60) for circulating the kidney preservation solution through the perfusion circuit, (d) a pump inlet line (2) that operatively connects the pump to the kidney cassette (7a) and the preservation solution reservoir (7b) for drawing preservation solution from the kidney cassette (7a) and the preservation solution reservoir (7b), and (e) a pump outlet line (1) that connects the pump to the gas exchanger for sending the preservation solution to the gas exchanger.

In another embodiment of the gas exchanger of the present disclosure, the perfusion circuit further comprises a filter for filtering impurities in the preservation solution that can block pathway of the preservation solution through the perfusion circuit.

In another embodiment of the gas exchanger of the present disclosure, the perfusion circuit further comprises a urine collector bag (6a) configured for connection to the ureter of the harvested donor kidney stored within the kidney cassette (7a) for collecting urine from the harvested donor kidney.

In another embodiment of the gas exchanger of the present disclosure, the perfusion circuit further comprises an air bubble sensor.

In another embodiment of the gas exchanger of the present disclosure, the perfusion circuit further comprises a purge line.

In another embodiment of the gas exchanger of the present disclosure, the perfusion circuit further comprises a manifold for sampling the preservation solution and/or adding medication agents to the preservation solution.

In another embodiment of the gas exchanger of the present disclosure, the harvested donor kidney is an integrated element of said perfusion circuit.

In another embodiment, the present disclosure provides for a perfusion circuit for circulating kidney preservation solution to and from a harvested donor kidney comprising: (a) a kidney cassette (7a) configured for storing the harvested donor kidney during a preservation period and for storing the kidney preservation solution, (b) a kidney preservation solution reservoir (7b) configured for storing the kidney preservation solution, (c) an oxygen reservoir (10a) and a carbon monoxide (CO) reservoir (10b), (d) a gas exchanger (5) for treating the kidney preservation solution, the gas exchanger comprising: (i) an inlet (51) for receiving oxygen and CO from the oxygen reservoir (10a) and the carbon monoxide (CO) reservoir (10b), (ii) an inlet (52) for receiving the kidney preservation solution to be treated in the gas exchanger, (iii) an outlet gas (9) out to environment, and (iv) an outlet (53) for delivering the organ preservation solution treated with oxygen and CO (treated preservation solution) to the kidney cassette and the kidney preservation solution reservoir, and (e) a perfusion circuit.

In one embodiment of the perfusion circuit for circulating kidney preservation solution of the present disclosure, the perfusion circuit comprises (e) a pump (60) for circulating the kidney preservation solution through the perfusion circuit, (f) a pump inlet line (1) that operatively connects the pump to the kidney cassette (7a) and the preservation solution reservoir (7b) for drawing preservation solution from the kidney cassette (7a) and the preservation solution reservoir (7b), and (g) a pump outlet line (2) that operatively connects the pump to the gas exchanger for sending the preservation solution to the gas exchanger.

In another embodiment of the perfusion circuit for circulating kidney preservation solution of the present disclosure, the perfusion circuit further comprises a urine collector bag (6a) configured for connection to the ureter of the harvested donor kidney stored within the kidney cassette (7a) for collecting urine from the harvested donor kidney.

In another embodiment of the perfusion circuit for circulating kidney preservation solution of the present disclosure, the perfusion circuit further comprises a filter for collecting impurities in the preservation solution that can block pathway of the preservation solution through the disposable perfusion circuit.

In another embodiment of the perfusion circuit for circulating kidney preservation solution of the present disclosure, wherein the perfusion circuit further comprises one or more of a flow, resistance, pressure monitor and/or an air bubble sensor.

In another embodiment of the perfusion circuit for circulating kidney preservation solution of the present disclosure, the perfusion circuit further comprises a purge line.

In another embodiment of the perfusion circuit for circulating kidney preservation solution of the present disclosure, the perfusion circuit further comprises a manifold for sampling the preservation solution and/or adding medication agents to the preservation solution.

In another embodiment of the perfusion circuit for circulating kidney preservation solution of the present disclosure, the harvested donor kidney is an integrated element of said perfusion circuit.

In another embodiment of the perfusion circuit for circulating kidney preservation solution of the present disclosure, the perfusion circuit further comprises a heating unit for maintaining the perfusion solution at a desired temperature.

In another embodiment, the present disclosure relates to a method to preserve a donor organ comprising perfusing the donor organ with a mixture of carbon monoxide and oxygen at room temperature. In one embodiment of the method to preserve a donor organ, the perfusing is done using the gas exchanger of the present disclosure. In another embodiment of the method to preserve a donor organ, the perfusing is done using perfusion circuit of the present disclosure.

### BRIEF DESCRIPTION OF THE FIGURES

The following figures illustrate various aspects and preferred and alternative embodiments of this disclosure.

FIG. 1A. A commercially available renal pump (RM3 medical system) modified for normothermic blood or Hemopure (HBOC) perfusion and reperfusion in the same unit.

FIG. 1B is a schematic of FIG. 1A.

FIG. 2. Schematic of a perfusion circuit according to one embodiment of the present disclosure. The circuit includes modifications to one of the perfusion pumps (Lifeport; Organ recovery systems Inc) that permits oxygenation and CO to be added to a perfusate having Hemoglobin-based oxygen carriers (HBOCs).

FIGS. 3A-3E. Oxygenated blood perfusion at 22° C. reduces Ischemia reperfusion injury in model DCD kidneys. Kidneys subjected to 30 min warm ischemia in situ were perfused/stored at different temperature as indicated. After 8 h, gross kidneys (3A) sections were stained with H &E (3B) to assess acute tubular necrosis (3C), kidney damage marker (3D) and urine function (3E). Blue circle and arrowheads indicate massive necrotic area and thrombi formation respectively.

FIGS. 4A-4D. Ex vivo perfusion with Carbon monoxide (CO) releasing molecule (CORM-401) reduced injury in porcine DCD kidneys. Kidneys subjected to 1 h warm ischemia in situ were perfusion with UW solution and active CORM-401 and inactive CORM-401 (iCORM-401) followed by 10 h blood reperfusion at 37° C. Sections were stained with H&E (not shown), TUNEL (4A) and MSB (4B) to quantify ATN (4C), Apoptosis (brown spot), Hemorrhage (yellow stain) and kidney injury (4D).

FIGS. 5A-5B. Ex vivo perfusion with hemoglobin-based oxygen carriers (HBOC) at 22° C. reduces apoptosis in porcine kidneys. (5A) TUNEL staining reveled apoptosis (brown staining). (5B) Apoptosis was scored by a qualified pathologist and is shown as percent of apoptotic tubule cells.

FIGS. 6A-6D: Ex vivo perfusion with hemoglobin-based oxygen carrier alone (HBOC) or with the addition of total parenteral nutrition (HBOC+TPN) show similar levels of acute tubular necrosis (ATN) and apoptosis in porcine kidneys. 6A) hematoxylin and eosin staining shows renal tubules sustained similar loss of tubule cells in HBOC and HBOC+TPN conditions. Scale bar=200 μm. 6B) No significant difference in acute tubular necrosis scoring was observed between the HBOC alone and HBOC+TPN groups; P=0.365. 5C) terminal deoxynucleotidyl transferase 2″-deoxyuridine, 5″-triphosphate nick end labeling (TUNEL) staining revealed similar levels of apoptosis (brown staining) in tubules of HBOC and HBOC+TPN perfused kidneys. 5D) Apoptosis was scored by a qualified pathologist and is shown as percent of apoptotic tubule cells; P=0.297. Results are displayed as mean±SEM; Student's t-test; n=6.

### DETAILED DESCRIPTION

### Abbreviations

Unless defined otherwise, all technical and scientific terms used herein have the same meaning as commonly understood by one of ordinary skill in the art to which this disclosure belongs. Also, unless indicated otherwise, except within the claims, the use of “or” includes “and” and vice versa. Non-limiting terms are not to be construed as limiting unless expressly stated or the context clearly indicates otherwise (for example “including”, “having” and “comprising” typically indicate “including without limitation”). Singular forms including in the claims such as “a”, “an” and “the” include the plural reference unless expressly stated otherwise. “Consisting essentially of” means any recited elements are necessarily included, elements that would materially affect the basic and novel characteristics of the listed elements are excluded, and other elements may optionally be included. “Consisting of” means that all elements other than those listed are excluded. Embodiments defined by each of these terms are within the scope of this disclosure.

All numerical designations, e.g., levels, amounts and concentrations, including ranges, are approximations that typically may be varied (+) or (−) by increments of 0.1, 1.0, or 10.0, as appropriate. All numerical designations may be understood as preceded by the term “about”.

### Overview

Donor kidneys are commonly stored at 4° C. in non-oxygenated machine perfusion. While this hypothermic method can increase storage times, they do not fully protect kidneys from ischemia reperfusion injury (IRI). However, it remains the gold standard in transplantation and an optimal method of oxygen delivery to ischemic kidneys during ex vivo storage has not been established. Since our previous studies have implicated the use of carbon monoxide (CO) releasing molecule in superior model porcine donor kidney preservation up to 10 h and beneficial effects of subnormothermic (15° C. to 32° C., preferably 22° C.) oxygenated perfusion of model porcine donor kidneys with acellular hemoglobin-based oxygen carrier (HBOC), we aimed to preserve human donor kidneys in these conditions with initial objective of storing beyond 12 h ex vivo. We have demonstrated that the combination of these components in a clinically relevant perfusion pump can improve kidney preservation (vs hypothermic pulsatile perfusion) in human kidneys (unpublished).

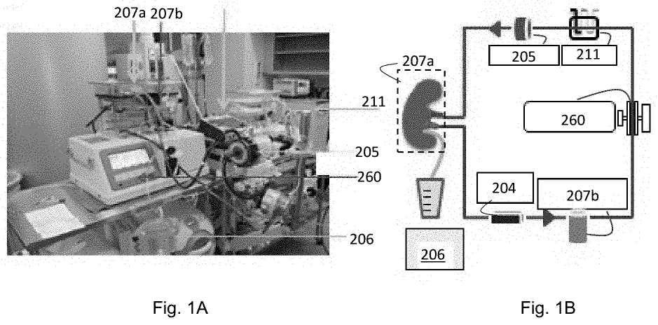

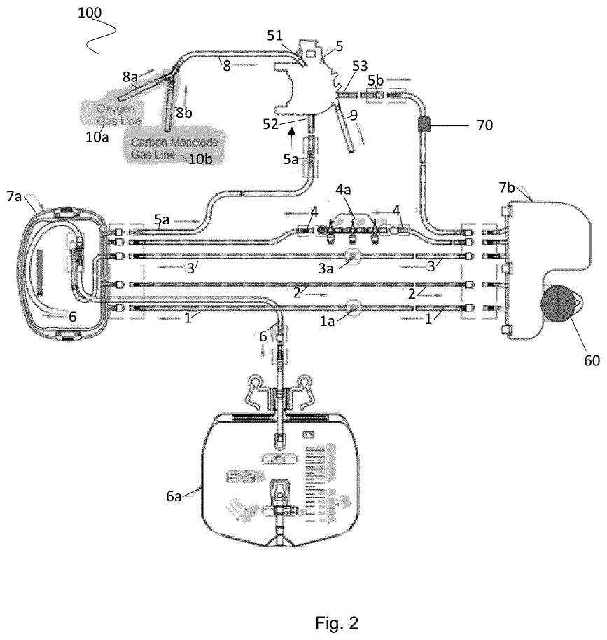

The present disclosure provides a strategy and methodology that combines the use of an organ perfusion circuit having oxygen/carbon monoxide insufflation lines that provides gaseous supplementation to protect a harvested organ. The application of an oxygen/carbon monoxide mixture in a subnormothermic environment for organ preservation has never been published and the circuitry (FIGS. 1B and 2) has never been published or described in publication or conference proceedings. This device is not limited to one type of machine perfusion device, as we have adapted it to two different devices by different manufacturers, namely the Lifeport® Kidney Transporter (Organ Recovery Systems, Inc.) and RM3 (Waters® Medical Systems).

By developing an efficient and efficacious method of ex vivo organ preservation, the present disclosure seeks to improve current logistical constraints related to organ preservation limits in clinical practice. In addition, organs that are well protected will contribute to its extended lifetime in recipients. Unique aspects of the present disclosure include the delivery of oxygen and carbon monoxide to the organ at subnormothermic temperatures (15° C. to 32° C., preferably about 22° C.).

(I) Perfusion Circuit for Circulating Kidney Preservation Solution to and from a Harvested Donor Kidney

With reference to FIG. 2, in one embodiment, the present disclosure provides for a perfusion circuit for treating and circulating kidney preservation solution to and from a harvested donor kidney comprising:

(a) a kidney cassette 7a configured for storing the harvested donor kidney during a preservation period and for storing the kidney preservation solution,

(b) a kidney preservation solution reservoir 7b configured for storing the kidney preservation solution,

(c) an oxygen reservoir 10a and a carbon monoxide (CO) reservoir 10b,

(d) a gas exchanger 5 for treating the kidney preservation solution, the gas exchanger comprising:

(i) an inlet 51 for receiving oxygen and CO from the oxygen reservoir 10a and the carbon monoxide (CO) reservoir 10b,

(ii) an inlet 52 for receiving the kidney preservation solution from the perfusion circuit,

(iii) an outlet gas 9 out to suction,

(iv) an outlet 53 for delivering the organ preservation solution treated with oxygen and CO (treated preservation solution) to the perfusion circuit,

(e) a pump 60 for circulating the kidney preservation solution through the perfusion circuit,

(f) a pump inlet line 2 that operatively connects the pump to the kidney cassette 7a and the preservation solution reservoir 7b for drawing preservation solution from the kidney cassette 7a and the preservation solution reservoir 7b, and

(g) a pump outlet line 1 that connects the pump to the gas exchanger for sending the preservation solution to the gas exchanger for treatment.

As kidneys do not produce urine in hypothermic states, urine collection devices are not utilized in unmodified perfusion pumps (HM3 and Lifeport). However, under subnormothermic or normothermic conditions, kidneys can make significant amounts of urine. Against this background, the applicant included a urine collector bag for normothermic and/or subnormothermic kidney perfusion circuits of the present disclosure. In one embodiment of the present disclosure, the perfusion circuit further includes a urine collector bag (6a) configured for connection to the ureter of the harvested donor kidney stored within the kidney cassette (7a) to collect urine (for analysis), and divert potentially pro-inflammatory waste from the circuit.

In one embodiment, the perfusion circuit further comprises a filter for collecting impurities in the preservation solution that can block pathway of the preservation solution through the disposable perfusion circuit.

In one embodiment, the perfusion circuit further comprises an air bubble sensor 70.

In one embodiment, the perfusion circuit further comprises a purge line.

In one embodiment, the perfusion circuit further comprises a manifold for sampling the preservation solution and/or adding medication agents to the preservation solution. Examples of medication agents include Calcium channel blockers (prevention of apoptosis), Liraglutide (cytokine inhibition), doxycycline (cytokine blockade), Metformin (TLR blockade), alprostadil (reduction of TNF alpha] and so forth.

In aspects of the present disclosure, the harvested donor kidney is an integrated element of said perfusion circuit.

The perfusion circuit 100 contains the kidney preservation solution necessary for perfusing a single kidney and is comprised of the following:
A pump outlet line 1 to inflow line 5a (see below) through a filter, if one is provided.
A venous sampling port 1a.
A pump inlet line 2 from kidney cassette 7a and reservoir 7b.
A treated (arterial) preservation solution inflow line 3 to the kidney.
An arterial sampling port 3a.
A purge line 4.
A sampling, solution and medication infusion manifold 4a, which in aspects is disposed on the purge line 4.
A gas exchanger 5.
An inflow line 5a to the gas exchanger 5.
An outflow line 5b from the gas exchanger 5.
A urine collection line 6 connecting the ureter of the harvested kidney to a urine collection bag 6a.
A kidney cassette 7a and solution reservoir 7b.
A gas line 8.
An oxygen gas line in 8a from an oxygen reservoir 10a.
CO gas line in 8b from a CO reservoir 10b.
A gas line out 9 of the gas exchanger 5 to release gases into the environment.

The circuit is attached to the pump 60 (mechanical perfusion device) which recirculates the perfusion solution through the circuit into the kidney. The pump 60 will monitor, pressure, temperature, resistance and flow. Perfusion solution is added to the kidney cassette 7a and solution reservoir 7b.

Once the pump 60 is started, the solution is drawn from the kidney cassette 7a and solution reservoir 7b through the pump inlet line 2, then through the pump outlet line 1 into an optional filter (not shown). The filter, if provided, collects any material in the solution that can potentially block or impede the fluid pathway. Once it is through the filter, the solution travels into the inflow line 5a through the gas exchanger 5 where it is oxygenated and treated with CO.

The treated solution with oxygen and CO then travels through the outflow line 5b past an air bubble sensor 70 on the tube frame platform into the solution inflow line 3 that goes into the kidney. Flow rates are adjusted based on the perfusion parameters on the readout on the pump. Solutions or medications can be added via the sampling, solution and medication manifold 4a.

Although FIG. 2 shows a set up for the Life port transporter, we have utilized this for the RM3 device as well (FIG. 1A). FIG. 1B is a schematic of FIG. 1A, in which the circuit 200 includes a kidney chamber 207a, a reservoir 207b, a RM3 peristaltic pump 260, a gas exchanger 205, a flow, resistance, pressure monitor 204, a heating unit 211 to keep the solution at a desired temperature, such as subnormothermic temperatures, and a urine bag 206 for collecting urine from the kidney.

(II). Method to Preserve a Donor Harvested Organ

This disclosure has required a few steps in the development of the procedure:

1. Subnormothermic (room temperature) perfusion optimally protects the kidney

We sought to find the ideal temperature for kidney preservation utilizing a clinically relevant pulsatile perfusion pump (RM3 pump in these experiments).

Methods. Donation after cardiac death conditions were simulated in a large male Landrace pig by cross-clamping the renal pedicle for 30 min. The left kidney was flushed with Histidine-tryptophan-ketoglutarate solution and subjected to cold storage for 4 h. The right kidney was cannulated for pulsatile oxygenated perfusion with syngeneic blood for 4 h in 15° C., 22° C. and 37° C. To mimic reperfusion post-transplant, all kidneys were reperfused with oxygenated whole blood for 4 h at 37° C.

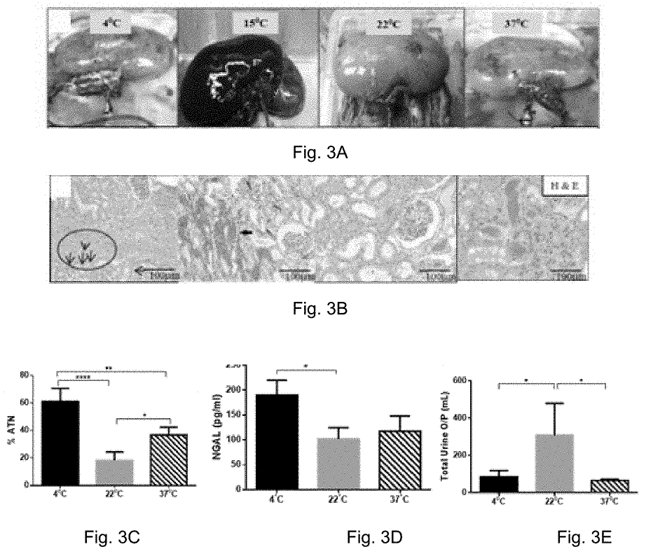

Results. Compared with all other groups, 22° C. perfusion resulted in optimal reduction of acute tubular necrosis (15-20%) (FIG. 3C) and Terminal deoxynucleotidyl transferase dUTP nick end labeling in histologic sections, attenuated kidney damage markers (Kidney injury molecule 1 and Neutrophil gelatinase-associated lipocalin), and were associated with the best renal blood flow and urine output. Kidneys stored at 15° C. thrombosed within 2 h under our conditions. Martius Scarlet Blue staining confirmed that 22° C. was the optimal temperature for perfusion without hemorrhage and blood clot formation. (FIGS. 3A-3E)

Conclusions. This study demonstrated that kidneys preserved at room temperature (22° C.) with oxygenated blood reduced IRI and provided the optimal temperature in which DCD kidneys are stored. This established our room temperature target for kidney pump preservation.

2. Hemopure is Equivalent to Blood with Regards to Oxygen Delivery to the Kidney During Ex Vivo Perfusion

In order to identify the simplest and best way to deliver oxygen to the organ we compared blood free oxygen carrier (Hemopure) vs. blood in preservation of the organs using the Waters machine.

Methods: Pig kidneys (n=5) were procured after 30 minutes of warm in situ ischemia by cross-clamping the renal arteries. Organs were flushed with histidine tryptophan ketoglutarate solution and subjected to static cold storage or pulsatile perfusion with an RM3 pump at 22° C. for 4 hours with HBOC-201 and blood. Thereafter, kidneys were reperfused with normothermic (37° C.) oxygenated blood for 4 hours. Blood and urine were subjected to biochemical analysis. Total urine output, urinary protein, albumin/creatinine ratio, flow rate, resistance were measured. Acute tubular necrosis, apoptosis, urinary kidney damage markers, neutrophil gelatinase-associated lipocalin 1, and interleukin 6 were also assessed.

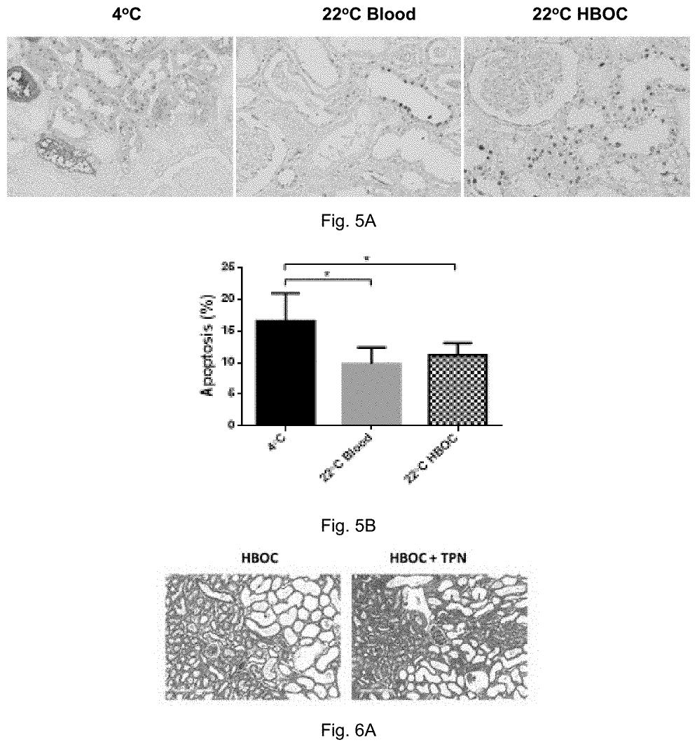

Results: HBOC-201 achieved tissues oxygen saturation equivalent to blood. Furthermore, upon reperfusion, HBOC-201 treated kidneys had similar renal blood flow and function compared with blood-treated kidneys. Histologically, HBOC-201 and blood-perfused kidneys had vastly reduced acute tubular necrosis scores and degrees of terminal deoxynucleotidyl transferase 2′-deoxyuridine, 5′-triphosphate nick end labeling staining versus kidneys treated with cold storage. Urinary damage markers and IL6 levels were similarly reduced by both blood and HBOC-201. (FIGS. 5A-5B)

Conclusions: HBOC-201 is an excellent alternative to blood as an oxygen-carrying molecule in an ex vivo subnormothermic machine perfusion platform in kidneys.

3. Carbon Monoxide Reduces Ischemia Reperfusion Injury Ex Vivo

A manganese-containing CO releasing molecules (CORM)-401 has recently been synthesized which can efficiently deliver 3 molar equivalents of CO. We report the ability of this anti-inflammatory CORM-401 to reduce ischemia reperfusion injury associated with prolonged cold storage of renal allografts obtained from donation after circulatory death in a porcine model of transplantation.

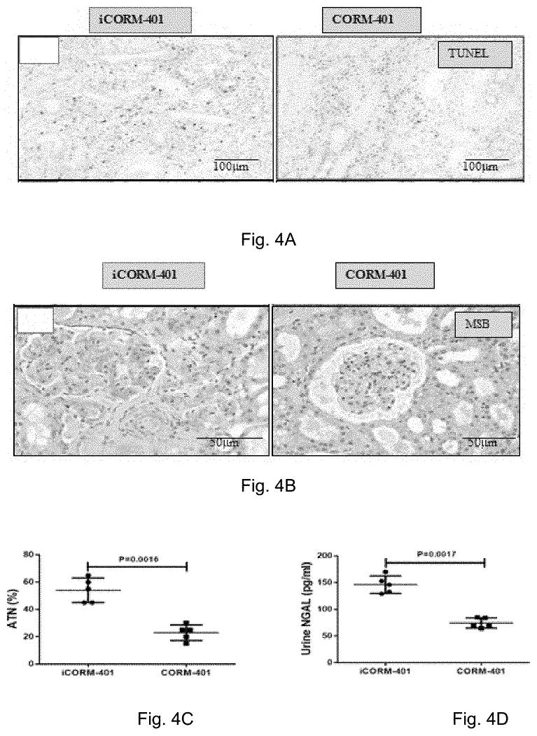

Methods: To stimulate donation after circulatory death condition, kidneys from large male Landrace pig were retrieved after 1-hour warm ischemia in situ by cross-clamping the renal pedicle. Procured kidneys, after a brief flushing with histidine-tryptophan-ketoglutarate solution were subjected to pulsatile perfusion at 4° C. with University of Wisconsin solution for 4 hours and both kidneys were treated with either 200 μM CORM-401 or inactive CORM-401, respectively. Kidneys were then reperfused with normothermic isogeneic porcine blood through oxygenated pulsatile perfusion for 10 hours. Urine was collected, vascular flow was assessed during reperfusion and histopathology was assessed after 10 hours of reperfusion. Sections were stained with H&E (not shown), TUNEL (FIG. 4A) and MSB (FIG. 4B) to quantify ATN (FIG. 4C), Apoptosis (brown spot), Hemorrhage (yellow stain), and neutrophil gelatinase-associated lipocalin (NGAL) to quantify kidney injury (FIG. 4D).

Results: We have found that CORM-401 administration reduced urinary protein excretion, attenuated kidney damage markers (kidney damage marker-1 and neutrophil gelatinase-associated lipocalin), and reduced ATN (FIG. 4C) and dUTP nick end labeling staining in histopathologic sections. CORM-401 also prevented intrarenal hemorrhage and vascular dotting during reperfusion. Mechanistically, CORM-401 appeared to exert anti-inflammatory actions by suppressing Toll-like receptors 2, 4, and 6. FIG. 3 demonstrate some of these features.

Conclusions: Carbon monoxide provides renal protection during storage of kidneys and provides a novel clinically relevant ex vivo organ preservation strategy. Although we have published on carbon monoxide releasing molecules, we have not published on delivering CO directly to the perfusate of the organ, which is part of our novel strategy.

4. Pulsatile Perfusion Vs Centrifugal Perfusion are Equivalent Methods for Organ Preservation

We have previously demonstrated benefits of kidney preservation utilizing an oxygenated subnormothermic ex vivo perfusion platform. Herein, we aim to compare pulsatile versus centrifugal (steady and uniform flow) perfusion with the goal of optimizing renal preservation with these devices. Materials and methods: Pig kidneys were procured following 30 min of warm ischemia by cross-clamping both renal arteries. Paired kidneys were cannulated and underwent either; oxygenated pulsatile or centrifugal perfusion using a hemoglobin oxygen carrier at room temperature with our ex vivo machine perfusion platform for 4 hr. Kidneys were reperfused with whole blood for 4 hours at 37° C. Renal function, pathology and evidence of inflammation were assessed post-perfusion. Results: Both pump systems performed equally well with organs exhibiting similar renal blood flow, and function post-reperfusion. Histologic evidence of renal damage using apoptosis staining and acute tubular necrosis scores was similar between groups. This was corroborated with urinary assessment of renal damage (NGAL 1) and inflammation (IL-6), as levels were similar between groups. Conclusion: In our porcine model with added warm ischemic simulating the effects of reperfusion after transplantation, pulsatile perfusion yielded similar renal protection compared with centrifugal perfusion kidney preservation. Both methods of perfusion can be used in ex vivo kidney perfusion systems. This prompted our development of an oxygen and CO delivery system that is compatible with the commercially available Lifeport (ORS) pump as well as the RM3 (Waters) pump (FIGS. 1A and 2).

5. Nutritional Supplementation is not Required for Subnormthermic Preservation of Organs Under 12 Hours.

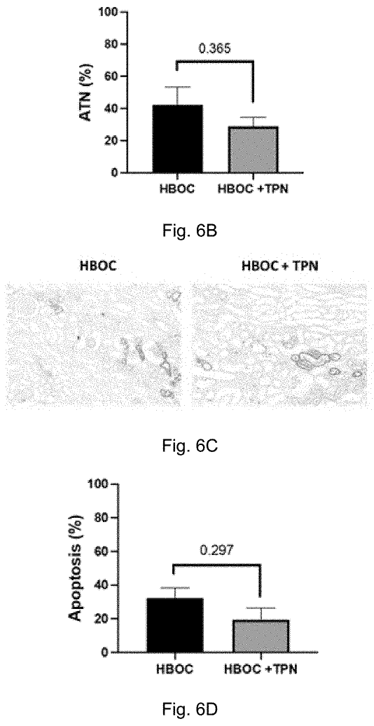

There is evidence that there may be benefit from nutritional supplementation to organs during normothermic ex vivo perfusion for organ preservation. However, it is unclear if nutritional supplementation provides any benefit during room temperature subnormothermic oxygenated perfusion. Methods: Porcine kidneys were recovered after 30 minutes of cross clamping the renal artery in situ to simulate warm ischemic injury during donation after circulatory death. After flushing with preservation solution, paired kidneys were cannulated and randomly assigned to pulsatile oxygenated perfusion with either 1) hemoglobin-carrier HBOC-201 or 2) HBOC-201+ total parenteral nutrition (TPN) for 12 h at 22° C. To create reperfusion injury; all kidneys were reperfused with whole blood for an additional 4 h at 37° C. Kidney function and damage were assessed. Results: Kidneys preserved with or without TPN performed equally well, showing similar renal function post-reperfusion. Histological findings indicated similar levels of renal damage from apoptosis staining and acute tubular necrosis scores in both groups. (FIGS. 6A-6D). Additionally, levels of renal damage (including urinary KIM-1, NGAL) and inflammation (IL-6, HMGB-1) were similar between the groups. Conclusion: Unlike other studies using normothermic oxygenated perfusion platforms, nutritional supplementation does not appear to be required during subnormothermic ex vivo kidney preservation over 12 hr. This firmly establishes the simplicity that a room temperature pulsatile perfusion pump affords compared with normothermic techniques.

In conclusion:
1. Subnormothermic/room temperature (15° C. to 32° C., preferably 22° C. or about 22° C.) is superior to normothermic (37° C.) vs hypothermic (4° C.) preservation (FIGS. 3A-3E).
2. Hemopure (HBOC) is an excellent oxygen carrier (FIGS. 5A-5B).
3. Infusion of carbon monoxide protects kidneys during machine preservation at physiologically relevant temperatures (FIGS. 4A to 4D).
4. Nutritional supplementation is not required to preserve the kidneys during 12-hour preservation times (FIGS. 6A-6D).

### REFERENCES

Bhattacharjee R N, Richard M, Haig A, Sun Q, Aboalsamh G, Barrett P,
Mayer R, Alhasan I, Luke Patrick. CORM-401 reduces ischemia
reperfusion injury in an ex vivo renal porcine model of the donation
after cardiac death. Transplantation. 2018; 102(7): 1066-1074
Bhattacharjee R N, Ruthirakanthan A, Sun Q, Richard M, Haig A, Mayer
R, Luke S, Aquil S, Sharma H, Tun-Abraham M E, Alharbi B, Haig A,
Sener A, Luke P P. Subnormothermic oxygenated perfusion optimally
preserves donor kidney ex vivo. Kidney International Reports, 2019; 4(9),
1323-1333

Patel S V B, Sener A, Bhattacharjee R N, Luke P P W. Machine
preservation of donor kidneys in transplantation. Transl Androl Urol.
2019 8(2): 118-125
Juriasingam S, Akbari M, Luke P, Sener A. Novel therapeutic strategies
for renal graft preservation and their potential impact on the future of
clinical transplantation. Curr Opin Organ Transplant. 2019 August;
24(4): 385-390.
Bhattacharjee R N, Patel S, Richard M, Haig A, Sun Q, Aquil S, Al-Ogaili
R, Jiang L, Ruthirakanthan A, Juriasingani s, Sener A, Luke P P Renal
Protection Against Ischemia Perfusion Injury: Hemoglobin Based Oxygen
Carriers vs. Blood as an Oxygen Carrier During Ex Vivo
Subnormothermic Machine Perfusion. Transplantation. 2020; 104(3):
482-489
Luke P P, Jiang L, Ruthirakanthan A, Lee D, Sun Q, Richard M, Kwong
J, Aquil S, Alogaili R, Haig A, Sener A, Bhattacharjee R N. Comparison
of centrifugal and pulsatile perfusion to preserve donor kidneys. Journal
of Investigative Surgery (2021). Jan 5: 1-7. doi:
10.1080/08941939.2020.1829212. Online ahead of print. PMID:
33400888.

Through the embodiments that are illustrated and described, the currently contemplated best mode of making and using the disclosure is described. Without further elaboration, it is believed that one of ordinary skill in the art can, based on the description presented herein, utilize the present disclosure to the full extent. All publications cited herein are incorporated by reference.

Although the description above contains many specificities, these should not be construed as limiting the scope of the disclosure, but as merely providing illustrations of some of the presently embodiments of this disclosure.

What is claimed is:

1. A gas exchanger for a perfusion circuit for circulating organ preservation solution to and from a harvested donor organ, the gas exchanger comprising:
(i) an inlet for receiving oxygen and CO from an oxygen reservoir and a carbon monoxide (CO) reservoir,
(ii) an inlet for receiving the organ preservation solution from the perfusion circuit,
(iii) an outlet gas out to environment, and
(iv) an outlet for delivering the organ preservation solution treated with oxygen and CO (treated preservation solution) to the perfusion circuit.

2. The gas exchanger of claim 1, wherein the gas exchanger further comprises the oxygen reservoir and the carbon monoxide (CO) reservoir connected to the inlet for receiving oxygen and CO.

3. The gas exchanger of claim 1, wherein the harvested donor organ is one of heart, kidney, liver, lung, pancreas, intestine, thymus or uterus.

4. The gas exchanger of claim 1, wherein the harvested donor organ is a harvested donor kidney, and the organ preservation solution is a kidney preservation solution, and wherein perfusion circuit comprises:
(a) a kidney cassette configured for storing the harvested donor kidney during a preservation period and for storing the kidney preservation solution,
(b) a kidney preservation solution reservoir configured for storing the kidney preservation solution,
(c) a pump for circulating the kidney preservation solution through the perfusion circuit,
(d) a pump inlet line that operatively connects the pump to the kidney cassette and the preservation solution reservoir for drawing preservation solution from the kidney cassette and the preservation solution reservoir, and
(e) a pump outlet line that connects the pump to the gas exchanger for sending the preservation solution to the gas exchanger.

5. The gas exchanger of claim 4, wherein the perfusion circuit further comprises a filter for filtering impurities in the preservation solution that can block pathway of the preservation solution through the perfusion circuit.

6. The gas exchanger of claim 4, wherein the perfusion circuit further comprises a urine collector bag configured for connection to the ureter of the harvested donor kidney stored within the kidney cassette for collecting urine from the harvested donor kidney.

7. The gas exchanger of claim 4, wherein the perfusion circuit further comprises an air bubble sensor.

8. The gas exchanger of claim 4, wherein the perfusion circuit further comprises a purge line.

9. The gas exchanger of claim 4, wherein the perfusion circuit further comprises a manifold for sampling the preservation solution and/or adding medication agents to the preservation solution.

10. The gas exchanger of claim 4, wherein said harvested donor kidney is an integrated element of said perfusion circuit.

11. A perfusion circuit for circulating kidney preservation solution to and from a harvested donor kidney comprising:
(a) a kidney cassette configured for storing the harvested donor kidney during a preservation period and for storing the kidney preservation solution,
(b) a kidney preservation solution reservoir configured for storing the kidney preservation solution,
(c) an oxygen reservoir and a carbon monoxide (CO) reservoir,
(d) a gas exchanger for treating the kidney preservation solution, the gas exchanger comprising:
(i) an inlet for receiving oxygen and CO from the oxygen reservoir and the carbon monoxide (CO) reservoir,
(ii) an inlet for receiving the kidney preservation solution to be treated in the gas exchanger,
(iii) an outlet gas out to environment, and
(iv) an outlet for delivering the organ preservation solution treated with oxygen and CO (treated preservation solution) to the kidney cassette and the kidney preservation solution reservoir,
(e) a pump for circulating the kidney preservation solution through the perfusion circuit,
(f) a pump inlet line that operatively connects the pump to the kidney cassette and the preservation solution reservoir for drawing preservation solution from the kidney cassette and the preservation solution reservoir, and
(g) a pump outlet line that operatively connects the pump to the gas exchanger for sending the preservation solution to the gas exchanger.

12. The perfusion circuit of claim 11, wherein the perfusion circuit further comprises a urine collector bag (6a) configured for connection to the ureter of the harvested donor kidney stored within the kidney cassette (7a) for collecting urine from the harvested donor kidney.

13. The perfusion circuit of claim 11, wherein the perfusion circuit further comprises a filter for collecting impurities in the preservation solution that can block pathway of the preservation solution through the disposable perfusion circuit.

14. The perfusion circuit of claim 11, wherein the perfusion circuit further comprises one or more of a flow, resistance, pressure monitor and/or an air bubble sensor.

15. The perfusion circuit of claim 11, wherein the perfusion circuit further comprises a purge line.

16. The perfusion circuit of claim 11, wherein the perfusion circuit further comprises a manifold for sampling the preservation solution and/or adding medication agents to the preservation solution.

17. The perfusion circuit of claim 11, wherein said harvested donor kidney is an integrated element of said perfusion circuit.

18. The perfusion circuit of claim 11, wherein the perfusion circuit further comprises a heating unit for maintaining the perfusion solution at a desired temperature.

19. A method to preserve a donor organ comprising perfusing the donor organ with a mixture of carbon monoxide and oxygen at room temperature.

20. The method of claim 19, wherein the perfusing is done using the perfusion circuit of claim 18.
